(19) United States
(12) Patent Application Publication
(10) Pub. No.: US 2026/0202843 A1
(43) Pub. Date: Jul. 16, 2026

(54) METHOD AND SYSTEM FOR DETECTING MISALIGNMENT BETWEEN LAYERS OF OPTIMIZATION FOR PHYSICAL PLANT

(71) Applicant: ExxonMobil Technology and Engineering Company, Spring, TX (US)

(72) Inventors: Ivan E. RODRIGUEZ COLON, Houston, TX (US); Peter J. HANRATTY, Spring, TX (US); Yunfei CHU, Humble, TX (US); William A. DOCTER, III, Beaumont, TX (US); Wayne JEREMIAH, Chandler's Ford (GB); Kenneth H. TYNER, Spring, TX (US)

(21) Appl. No.: 19/440,033

(22) Filed: Jan. 5, 2026

Related U.S. Application Data
(60) Provisional application No. 63/743,906, filed on Jan. 10, 2025.

(51) Int. Cl. G05B 23/02

(52) U.S. Cl. CPC G05B 23/0294; G05B 2223/02

(57) ABSTRACT

An example system includes a computer program that detects a misalignment for a variable between two layers of multiple layers of optimization. The computer program determines a degree of the misalignment between the two layers of optimization using a dimensionless metric. The computer program ranks the misalignment using a degree of misalignment. The computer program determines diagnostic information using patterns of the ranked misalignment. The system includes a physical plant that includes adjustable components that are adjusted using the diagnostic information according to the ranked misalignment to synchronize the misalignment between the two layers of optimization.

### CROSS-REFERENCE TO RELATED APPLICATION

This application claims the benefit of U.S. Provisional Application Serial No 63/743,906, entitled “METHOD AND SYSTEM FOR DETECTING MISALIGNMENT BETWEEN LAYERS OF OPTIMIZATION FOR PHYSICAL PLANT,” filed January 10, 2025, the disclosure of which is hereby incorporated by reference in its entirety.

### FIELD OF THE INVENTION

The present application relates generally to the field of physical plant operations. Specifically, the disclosure relates to a methodology for improving plant operation in a chemical plant or refinery.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Modern processing plants often have many different layers of optimization and control. For example, these layers can include a base control layer as well as a Model Predictive Control (MPC) layer, a Real-Time Optimization (RTO) layer, Scheduling layer, and Planning layer. In general, the multiple layers of optimization and control are used in a hierarchical manner, with results from higher layers sent down as targets to lower layers. In some cases, information may also flow from lower to higher layers based on analysis of misalignment, such as in model validation.

### SUMMARY OF THE INVENTION

An embodiment provided herein relates to a system that includes a computer program that detects a misalignment for a variable between two layers of multiple layers of optimization. The computer program also determines a degree of the misalignment between the two layers of optimization using a dimensionless metric. The computer program ranks the misalignment using a degree of the misalignment, and determines diagnostic information using patterns of the ranked misalignment. The system includes a physical plant that includes adjustable components that are adjusted using the diagnostic information according to the ranked misalignment to synchronize the misalignment between the two layers of optimization.

Another embodiment provided herein related to a method of operating a physical plant. The method includes detecting a misalignment of a variable between two layers of multiple layers of optimization. The method includes determining diagnostic information using patterns of the ranked misalignment. The method includes ranking the misalignment using a degree of misalignment. The method includes adjusting adjustable components of the physical plant using the diagnostic information according to the ranked misalignment to synchronize the misalignment between the two layers of optimization.

These and other features and attributes of the disclosed embodiments of the present techniques and their advantageous applications and/or uses will be apparent from the detailed description that follows.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a block diagram of an exemplary hierarchy of optimization and control layers, in accordance with the present techniques;

FIG. 2A is a graph of an exemplary dimensionless metric that is piecewise linear, in accordance with the present techniques;

FIG. 2B is a graph of an exemplary dimensionless metric being scored for a discrepancy in pressure, in accordance with the present techniques;

FIG. 3 is a time series graph and process flow diagram depicting an exemplary calculation of economics of a misalignment, in accordance with the present techniques;

FIG. 4 is a screenshot of an exemplary interface summary view of a web-based portal application, in accordance with the present techniques;

FIG. 5 is a screenshot of an exemplary RTO application specific page with detailed results, in accordance with the present techniques;

FIG. 6 is a screenshot of an exemplary screenshot of a web-based portal application including a time series graph of a dimensionless metric and graph of an example economic metric for one variable, in accordance with the present techniques;

FIG. 7 is a process flow diagram of an exemplary method for operating a physical plant, in accordance with the present techniques;

FIG. 8 is a block diagram of an exemplary cluster computing system that may be utilized to implement the present techniques;

FIG. 9 is a block diagram of an exemplary non-transitory, computer-readable storage medium that may be used for the storage of data and modules of program instructions for implementing the present techniques;

FIG. 10 is a time series graph of an exemplary detailed view for a specific variable being optimized by both an RTO and MPC, in accordance with the present techniques;

FIGS. 11A and 11B are screenshots of an exemplary frozen present value (PV) intelligent filter, in accordance with the present techniques; and

FIGS. 12A, 12B, and FIG. 12C are screenshots of an exemplary detailed portal page displaying an exemplary persistent gap for the dimensionless MPC-RTO Alignment Grade (DRAG) variable in a specific unit, in accordance with the present techniques.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, a “dummy bound” refers to a limit used for the purposes of calculating an economic incentive.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “physical plant” refers to a structure in which a facility is located and all physical appurtenances to the facility and machinery within the facility. A facility is a place where a particular activity occurs. For example, the facility may be a chemical processing facility, or hydrocarbon processing facility, etc. The machinery within the facility may have any number of adjustable components. Such adjustable components may include physical components such as valves, pumps, filters, chemical additives, etc.

Generally speaking, the term “pressure” refers to a force acting on a unit area. Pressure is typically provided in units of pounds per square inch (psi), but may be provided in units of pounds per square inch gauge (psig).

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or carbon dioxide (CO₂) is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, a “shadow value” refers to the economic value of relaxing a constraint by one unit in an optimization at a particular layer of optimization. For example, the economic value may be measured in any suitable unit. Shadow values may thus be calculated for a particular variable at each of any number of optimization layers. A shadow value analysis uses shadow values to evaluate the economic value based on experience or information derived from economic models.

If there is any conflict in the usages of a word or term in this specification and one or more patent or other documents that may be incorporated herein by reference, the definitions that are consistent with this specification should be adopted for the purposes of understanding this disclosure.

### Overview

As previously mentioned, processing plants often have multiple layers of optimization. However, the programs in the different optimization layers may be run by different optimizers. In some examples, the different optimization layers may be run by different machines and based on different scopes and requirements. Thus, the models, objective functions and optimization algorithms used in such optimization layers can be different, even though the optimization layers contain common variables. Moreover, because higher-level optimization programs are executed at lower frequencies, the targets calculated by an upper layer may drift further away from the true optimum when there are process changes or disturbances between upper layer execution cycles. Similarly, lower-level optimization programs may also drift away from a true optimum for various reasons.

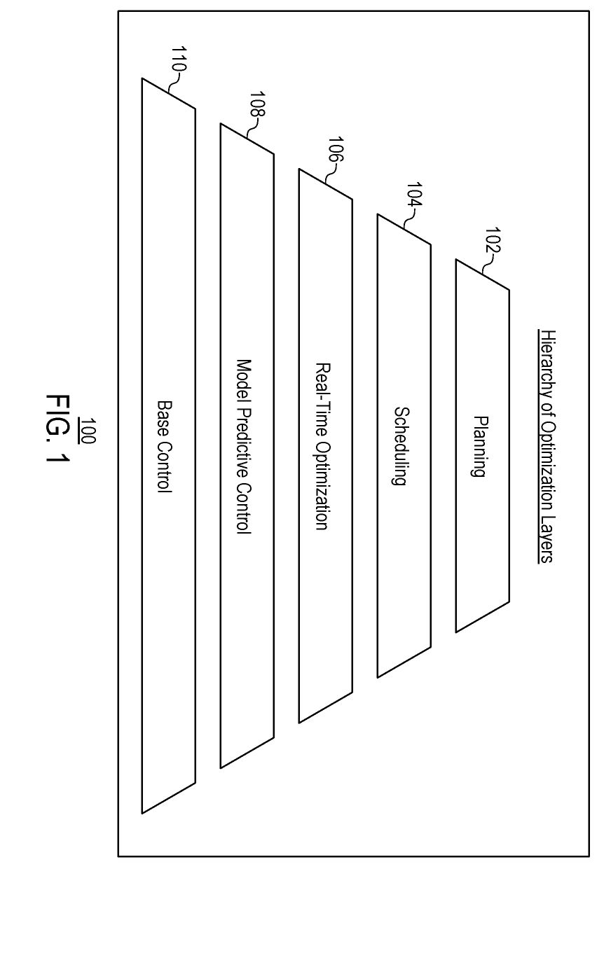

The present techniques provide a method to assess the alignment between the different optimization layers. One exemplary method is provided for assessing the alignment between optimizers of two different layers of optimization, with each layer having a model of the process. The method includes identifying the alignment for each variable. The method includes aggregating the degree of misalignment per a dimensionless metric. The method includes calculating economics of the misalignment based on shadow values. The method includes calculating the economics of the misalignment based on techniques derived from the higher-level optimization application. Thus, the techniques described herein are general techniques that allows different layers with different model types, objective functions, solution types or computing platforms to be assessed. The techniques enable assessment and ranking of misalignments between optimization layers. An example hierarchy of optimization layers that can be synchronized using the techniques described herein is described with respect to FIG. 1.

The present techniques may derive one or more benefits. First, the techniques enable synchronization of different optimization layers and thus more optimal operation in processing plants. In addition, the techniques enable synchronization of the optimization layers to be performed more efficiently by addressing misalignments with higher impacts first.

### Exemplary Optimization Layers Implemented using the Present Techniques

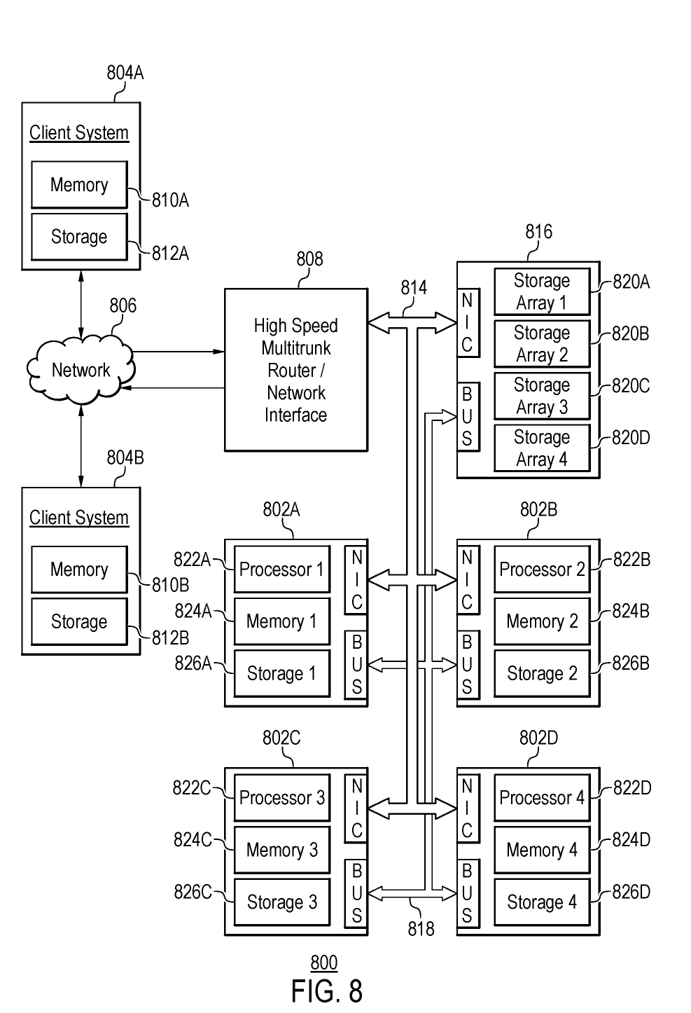

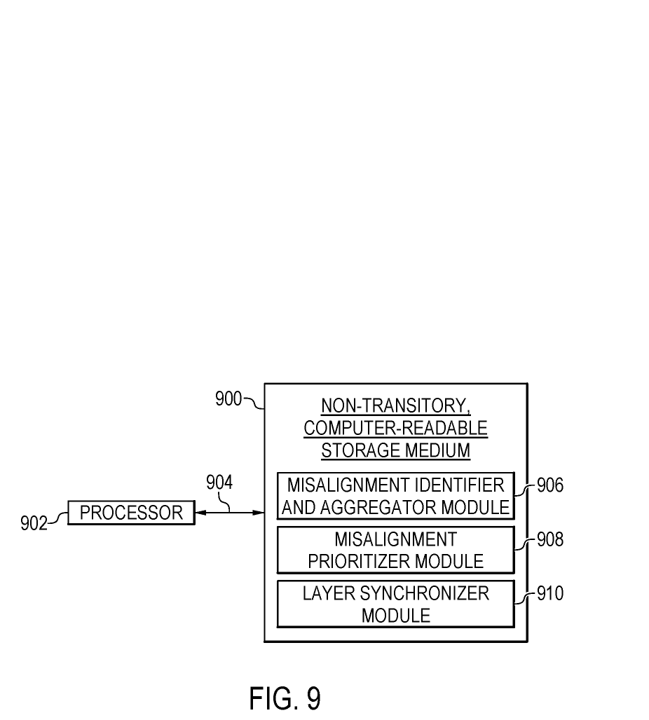

FIG. 1 is a block diagram of an exemplary hierarchy of optimization and control layers, in accordance with the present techniques. The exemplary hierarchy 100 includes a planning layer 102, a scheduling layer 104, a real-time optimization (RTO) layer 106, a model predictive control (MPC) layer 108, and a base control layer 110. In various embodiments, the hierarchy 100 is implemented using one or more processors, such as those in the cluster computing system 800 of FIG. 8, or the processor 902 of FIG. 9, described below.

The planning layer 102 is shown at the top of the hierarchy 100. In various embodiments, the planning layer 102 includes any number of planning programs that use a model of a process facility, or even multiple processing facilities, to represent production capabilities and constraints. In some embodiments, an optimizer is used to calculate optimal feedstock procurement, sales strategy, and facilities' utilization. For example, the planning layer 102 may include purchase of a particular crude oil and a selection of specific means by which the crude will be procured. In various embodiments, the frequency of execution of the planning layer 102 is on the order of weeks or months. In some embodiments, the planning layer 102 is alternatively divided into a short-term planning layer above the scheduling layer 104, and a long-term planning layer beneath the scheduling layer 104. For example, the short-term planning layer optimizes short term goals. The long-term planning layer optimizes long term goals.

The scheduling layer 104 optimizes a set of variables for a process facility. For example, the scheduling layer 104 can use a model of the process facility to represent individual unit capabilities, capacities, and constraints. In some embodiments, an optimizer is used to calculate the timing and disposition of available feeds and products. In some embodiments, the scheduling layer 104 may receive high level directives from a person working with a particular model. As one example, the scheduling layer 104 may receive the directive that a tank is full, or that a ship is incoming to pick up the full tank. As another example, the directive may be that a ship is stuck, and thus not able to pick up a particular tank at a specific time. In various embodiments, the frequency of execution of the scheduling layer 104 is on the order of days or weeks.

The RTO layer 106 optimizes the variables for a set of real-time factors. For example, the RTO layer 106 can include any number of a class of applications that use more non-linear (such as physics-based) process models and economics to find more accurate optima, which may be difficult or impossible to find using the models from the MPC layer 108 algorithms discussed below. In various embodiments, the frequency of execution for the RTO layer 106 is on the order of hours. For example, in some embodiments, the MPC layer 108 is a control system of a processing plant or refinery that provides directions and targets to the MPC layer 108. As one example, the RTO layer 106 may set and update a constraint such as a target temperature for the MPC layer 108.

The MPC layer 108 predicts changes in dependent variables in response to receiving one or more inputs. In various embodiments, the MPC layer 108 includes any of a class of algorithms that use a dynamic model to predict the dependent variables (i.e., the outputs or control moves) of a dynamic system with respect to changes in the process independent variables (i.e., the inputs), and to move the process independent variables in a more optimal fashion. For example, the dynamic model can be physical or empirical. In various examples, the dynamic model may be linear or nonlinear. For example, linear models used in the MPC can include step response models, transfer function models, state-space models, or any combination thereof. In some embodiments, the steady-state targets for the independent variables are determined by an objective function, which may be economic or non-economic. For example, an objective function may be a mathematical expression used to model the relationship between different factors that generate value. One example of a non-economic objective is the sum of weighted MPC variables. The weights in such an example are often referred to as Linear Programming Costs. This example can also become an economic objective if the weights are calculated from economic prices. One example of an economic objective approach is to include all feed/product material balance flow rates as MPC variables. The feed/product prices then form a set of controlled variable (CV) costs that can be used to converted to equivalent manipulated variable (MV) costs.

In various embodiments, the frequency of execution of the MPC layer 108 is on the order of minutes or seconds. For example, in some embodiments, the MPC layer 108 is a control system that continuously adjusts valves of a processing plant or refinery into a particular state at a particular time in order to push to a set of constraints.

In some cases, a misalignment may exist between the optimized value of one or more variables between two or more of the planning layer 102, the scheduling layer 104, the RTO layer 106, the MPC layer 108, and/or a base control layer 110. For example, if the instructions from the RTO layer 106 to the MPC layer 108 are not complete or inconsistent, then the optimizers for the RTO layer 106 and the MPC layer 108 may be moving a target in different directions or in the same direction, but by different magnitudes. In various examples, the instructions may be incomplete due to any combination of different reasons. The interface between the RTO and MPC layer may pass a full set of targets for the MPC layer to selectively implement; however, a subset of targets may typically be sent based on the designer’s understanding of which variables are best driven by RTO optimization versus higher frequency constraint pushing control. In some situations, the selected target set may not include enough information to keep the applications sufficiently aligned. As another example, instructions may be incomplete if there is a download configuration error that is preventing some targets from being transferred to the MPC layer from the above optimization layer. In some examples, instructions may be incomplete if any number of variables selected as targets may not be enough to implement all above optimization layer tradeoffs in the MPC layer. For example, target strategies often transfer only enough targets to implement expected tradeoffs and sometimes leave MPC native drives (e.g., linear programming (LP) costs) to govern MPC variables expected to always drive in the same direction to a limit. In such strategies, if the above layer optimization generates a solution that deviates from the untargeted MPC variable drives, the solution will not be fully implemented.

In various examples, the instructions may be inconsistent due to any combination of factors. For example, the instructions may be inconsistent due to different optimized values used by the different layers. In some examples, the instructions may be inconsistent due to incorrect input data to one either the MPC or the above layer optimizer. For example, data communication to above layer optimizer may break, resulting in some input values becoming frozen and not updating. In some examples, the instructions may be inconsistent because operations may have disabled some of MPC functionality resulting in incomplete implementation of above optimization layer targets. In some examples, the instructions may be inconsistent because the target implementation configuration in the MPC is not adequate to implement the targets as intended. For example, with respect to a Dynamic Matrix Control (DMC) MPC specifically, this could mean an external target (ET) range is too high, dynamic equal concern errors (ECEs) are too high, a one-sided or two-sided target approach not being configured correctly, or ET ranks are not in a correct order. In some examples, the RTO model may have a mistake in configuration or other inaccuracy which causes the targets sent to not make physical sense. For example, an application may have a material balance error and send feed and product rate targets which are not achievable.

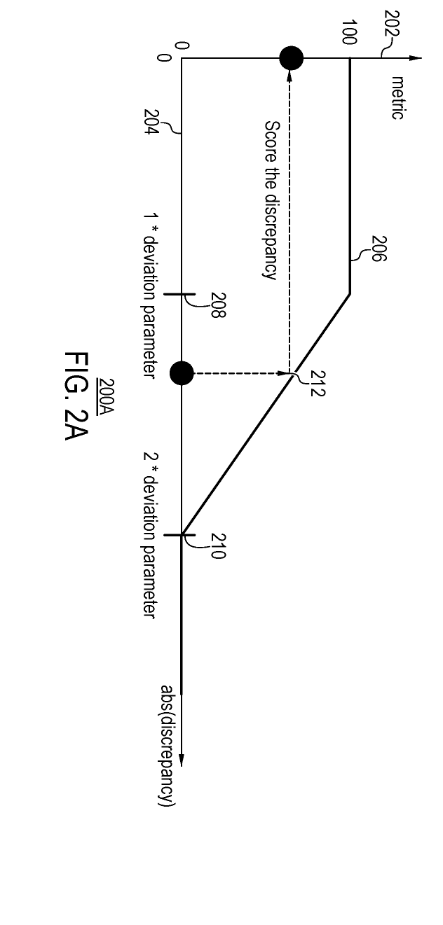

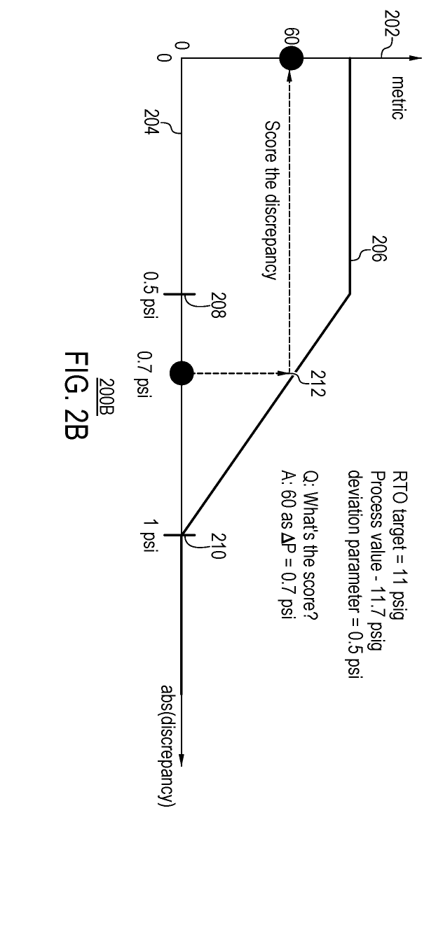

Therefore, in various embodiments, an application can detect misalignments based on any combination of a dimensionless metric, and various economic-based metrics. For example, the dimensionless metric quantifies the degree of alignment and aggregates this alignment score over a given period. In various embodiments, the dimensionless metric may be piecewise linear, as shown in the example of FIG. 2A. In some embodiments, nonlinear versions of the dimensionless metric can be used to transition between categorizing a variable from being aligned to being unaligned. For example, a nonlinear version may use a normal distribution or other statistical functions. In some embodiments, an economic-based metric leverages economic shadow values to quantify the economic incentive of the misalignment. In various examples, an economic-based metric may be a more approximate value. In some embodiments, an economic-based metric utilizes a higher-level optimization to assess the misalignment. For example, more detailed simulations may be used in order to generate an economic metric. As one example, in evaluating a misalignment between an RTO and MPC layer, the model for the RTO itself may be used in a simulation to generate an economic-based metric. The resulting economic-based metrics can be used to detect misalignment between the optimization layers and rank the detected misalignments in order of economic value. In some embodiments, an application output prioritizes the results based on the ranking by economic metric. This enables prioritization of the troubleshooting among variables and thus more efficient synchronization between the different optimization layers.

### Exemplary Dimensionless Metric

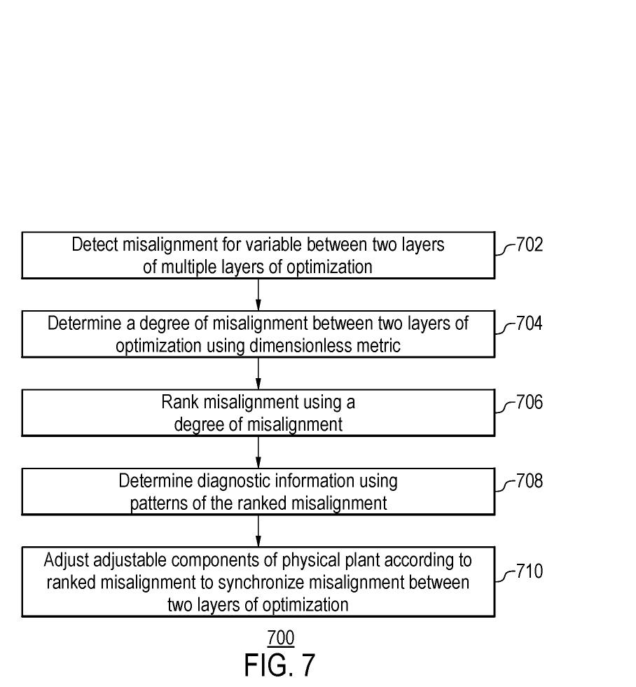

FIG. 2A is a graph 200A of an exemplary dimensionless metric that is piecewise linear. The graph 200A of FIG. 2 includes a vertical axis with values for the dimensionless metric 202 and a horizontal axis representing discrepancy 204 measured in absolute values with respect to multiples of a deviation parameter. For example, a deviation parameter may represent a level of noise in a particular variable. A line 206 represents dimensionless metric values for a range of discrepancy values. Two example discrepancy values of a single deviation parameter 208 and double the deviation parameter 210 are also shown in the graph 200A. In various embodiments, the dimensionless metric is implemented in the method 700 of FIG. 7.

As shown in FIG. 2A, in various embodiments, a dimensionless metric is calculated by first converting a discrepancy into multiples of a determined deviation parameter. For example, a deviation parameter may be an average change seen in misalignment between two optimization layers for a particular variable. Once the misalignment is converted to a factor of a deviation parameter, the value is converted into a dimensionless metric value by matching the horizontal value corresponding to the discrepancy with the associated vertical value on the line 206 at point 212. In various embodiments, the metric function represented by line 206 is a linear function. Specifically, in FIG. 2A the linear function is a piece-wise linear function of the absolute value of discrepancy. As FIG. 2A shows, the discrepancy range is divided into three segments by the deviation parameter, which is a tuning parameter for a particular variable. For example, a tuning parameter is any user selected parameter that may be based on user knowledge of the system and/or analysis of the variable corresponding to the tuning parameter. The first segment is a 0 – 1.0 multiple of the deviation parameter; the dimensionless metric for these values is 100. A discrepancy between values of two layers within the deviation parameter may thus be considered aligned. The second segment is a 1.0–2.0 multiple of the deviation parameter; the dimensional metric is a linear decreasing function for these values. Discrepancies in between these values are associated a score between 0-100. The third segment covers double the deviation parameter to infinity; the resulting dimensionless metric for these values is zero. Thus, a discrepancy that has a value beyond double the deviation parameter may be considered a completed misalignment between the two layers. The resulting dimensionless metric score within the range of 0-100 thus quantifies the current degree of alignment by aggregating the alignment over a given period.

FIG. 2B is a graph 200B of an exemplary dimensionless metric being scored for a discrepancy in pressure. FIG. 2B includes similarly referenced elements of FIG. 2A. In the example of FIG. 2B, the deviation parameter for the psi variable was calculated as 0.5 psi by processing a dataset. However, in various embodiments, the deviation parameter is set by an end user or designer of one of any number of optimization applications. In the example of FIG. 2B, the deviation parameter 208 is 0.5 psi and double the deviation parameter 210 is 1.0 psi. The value of 0.7 psi corresponds to the point 212 on line 206, which is associated with a dimensionless metric score of 60. Thus, for a given RTO target of 11 psig, a given process value of 11.7 psig, and deviation parameter of 0.5 psi, the dimensionless metric score for a pressure change of 0.7 psi is 60.

### Exemplary Economic -based Metric Calculation Techniques

In various examples, variables have different impacts on a process. For example, a small deviation in one temperature of a process can matter more than a large deviation in another temperature. Hence, variable scaling may be implemented using a deviation parameter. In this regard, a deviation parameter can be used as a tuning parameter for each variable to tune the relative importance between variables. However, such tuning is not directly related with any economic values. Therefore, in various embodiments, to evaluate the economic values, model-based approaches as well as a shadow value analysis are used. In some embodiments, when a discrepancy between the higher-level target and the lower level occurs, a dummy bound is set to force the target to move to the plant value so that the monetary values can be seen when the bound is changed. Thus, the economic value of a discrepancy between a target calculated at one level and the implementation achieved at a level below can be estimated by forcing the higher level application to generate a solution matching the observed implementation for the variable being analyzed.

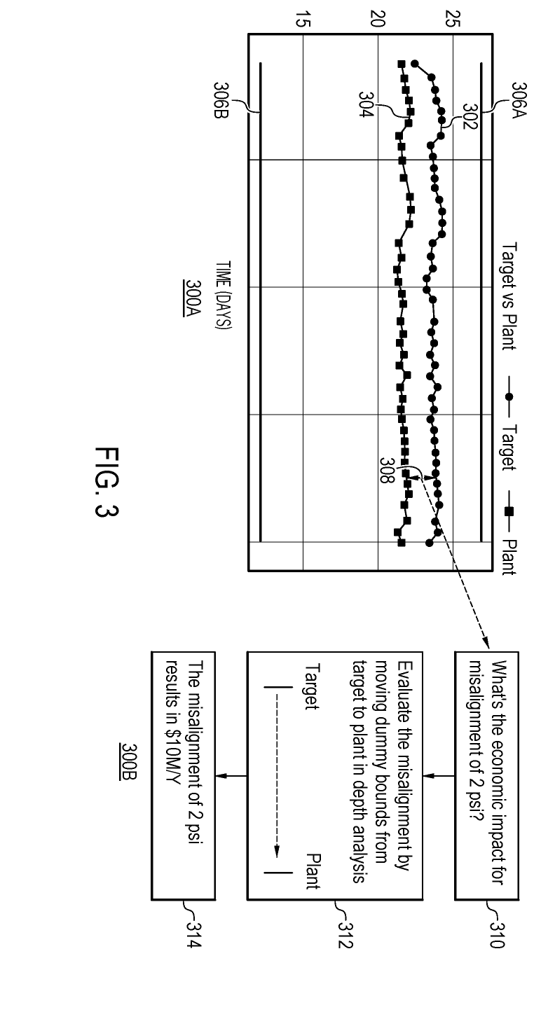

FIG. 3 is a time series graph 300A and process flow diagram 300B depicting an exemplary calculation of economics of a misalignment. FIG. 3 includes a time series graph 300A of an example discrepancy that can be analyzed using techniques described herein. The time series graph 300A includes a time series of optimized targets 302 and a time series of plant values 304 received from a physical plant, and a time series of operating bound values, including an upper bound 306A and a lower bound 306B. For example, an optimized limit represented by upper bound 306A is calculated using a highest layer of optimization. A discrepancy 308 is further shown between the plant value 304 and the optimized target 302.

Thus, at block 310 of flow process diagram 300B, an economic query is generated. For example, the economic query may be: what is the economic impact for a misalignment of two psi?

At block 312, the misalignment is evaluated using economic-based metrics by moving dummy bounds from a target value to a plant value in an analysis tool. For example, the analysis tool may include adjusting the misalignment by tightening an RTO target towards the plant values or relaxing the RTO target towards engineering limits. In various embodiments, the discrepancy of about two psi is converted into an economic metric using techniques described herein.

At block 314, an economic-based metric is output. For example, in the case of example misalignment shown in 300A, the misalignment of two psi results in an output an economic metric value of $10,000,000 per year. In various embodiments, the metric value is used to rank the misalignment with other misalignments in the system. The example misalignment depicted in graph 300A may be given priority over another detected misalignment that may only have a lower output economic metric value of $10,000 per year.

### Exemplary web-based portal implementation

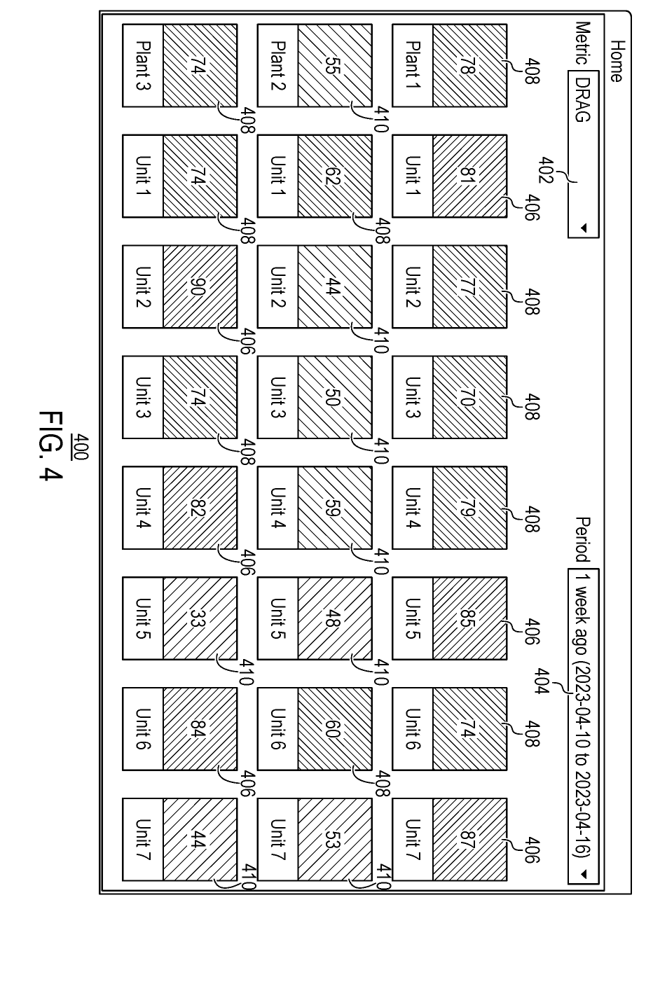

In various examples, an application for calculating and displaying information about discrepancies between various optimization layers includes algorithms and techniques to assess the misalignment. The analysis’ results can be displayed in several formats and interfaces. One example format and interface is using a web-based portal per the following example implementation described in FIGS. 4-6, which depict different example pages and features of a web-based portal used as interface to display the results.

FIG. 4 is a screenshot of an exemplary interface summary view 400 of a web-based portal application. In various embodiments, the interface summary view 400 is implemented in an application using one or more processors, such as those in the cluster computing system 800 of FIG. 8, or the processor 902 of FIG. 9.

In various embodiments, a portal page of an application displays the results for different sites and the aggregated MPC and RTO alignment dimensionless metric score. For example, the interface summaryview 400 may provide a summarized fleet level view of various applications. In some embodiments, the portal page displays the individual RTO applications at each site along with their aggregated dimensionless metric score, as shown in FIG. 4. The example interface summary view 400 of FIG. 4 includes a selected metric of analysis 402, a selected period for analysis 404, and the various individual RTO applications that are marked using different cross shading as high scoring 406, medium scoring 408, or low scoring 410. In various embodiments, the cross shading is replaced with any suitable color scheme. For example, high scoring 406 applications may be colored green, medium scoring 408 applications may be colored yellow, and low scoring 410 applications may be colored red.

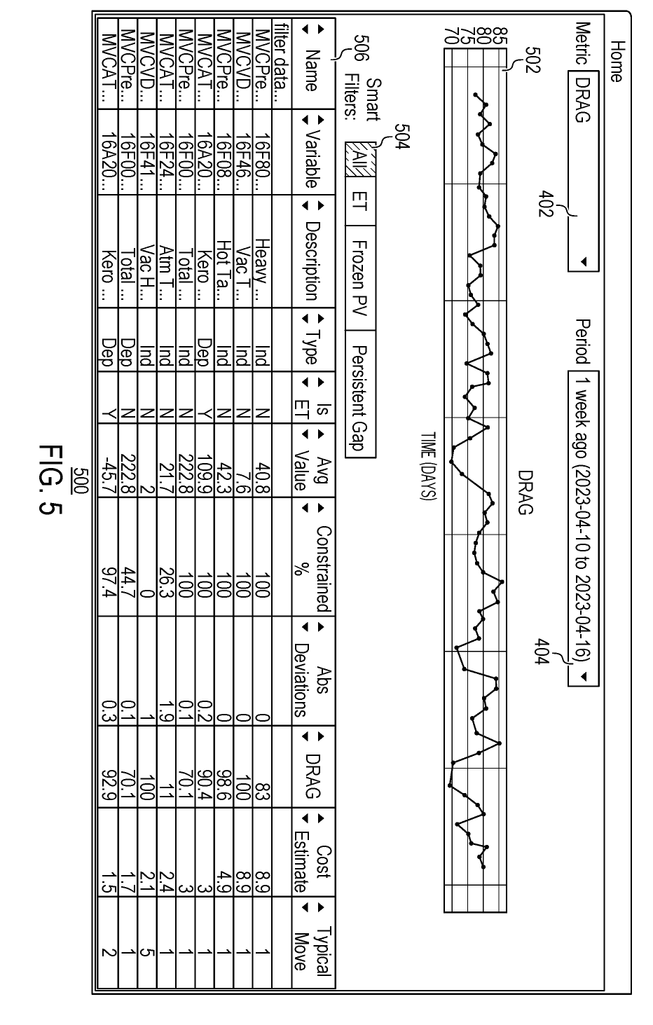

In some embodiments, a click on the tile corresponding to a specific RTO triggers the display of the display of detailed results of this misalignment application corresponding to that RTO application and its variables. In this manner, different levels of information may be displayed with different levels of granularity. Such an example detailed results page is shown in FIG. 5. In some embodiments, the portal page can also further include a time series visualization as well as an initial pattern recognition to help the user start diagnosing the problem for each variable. For example, in various embodiments, the portal page may include initial diagnostic tools to help display the misalignment application results and to aid diagnosis.

FIG. 5 is a screenshot 500 of an exemplary RTO application specific page with detailed results. The screenshot includes similarly referenced elements of FIG. 4. For example, the screenshot 500 includes a selected metric of analysis 402 and selected period for analysis 404. In the example of FIG. 5, the selected metric of analysis 402 is a dimensionless MPC-RTO Alignment Grade (DRAG). The selected period of analysis 404 is the week spanning from 2023-04-10 to 2023-04-16.

The screenshot 500 includes a time series graph 502 depicting values of the selected DRAG metric of analysis 402 over the selected period of analysis 404 for a specific unit of a refinery. In the example, of FIG. 5, the values of the DRAG metric range from approximately 68 to 87.

The screenshot 500 includes a list of smart filters 504. The smart filters 504 include a currently selected “All” tab in which no filter is applied and all columns are displayed. The smart filters 504 include an ET filter, frozen present value (PV) filter, and persistent gap filter.

The screenshot 500 further includes a table 506 listing names, and associated variable names, descriptions, variable types, ET status, average value, constrained percentage, absolute deviation values, DRAG values, cost estimates, and deviation parameter values.

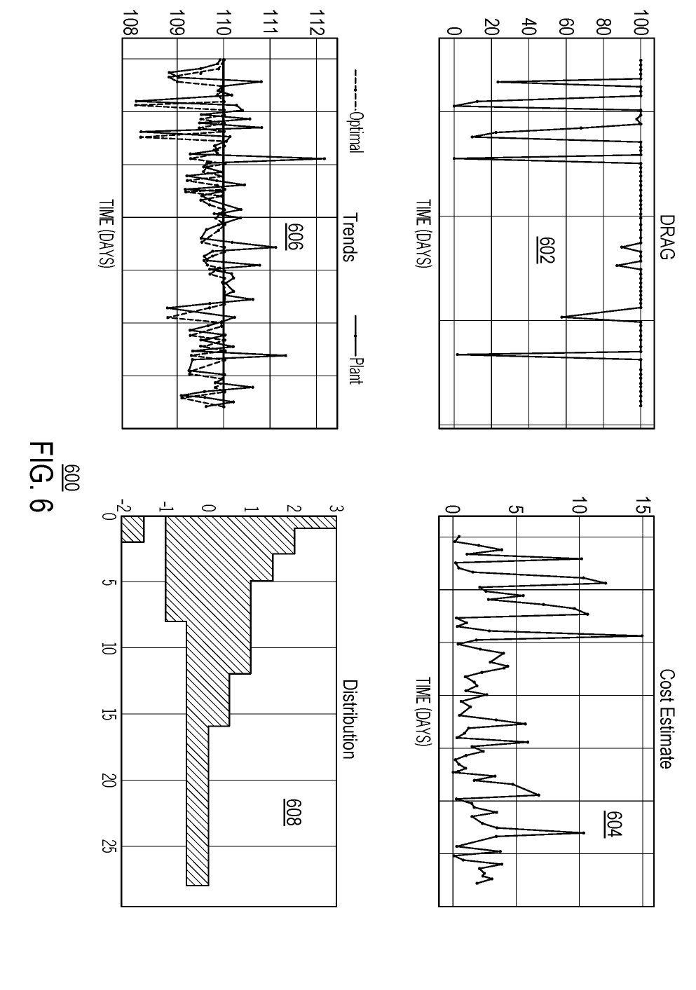

FIG. 6 is a screenshot 600 of a web-based portal application that shows time series graph 602 of the dimensionless metric and a graph 604 for an economic metric for one of the model variables. The screenshot 600 also shows the time series graph 606 of the RTO optimization and the plant value and a distribution graph 608 for the time series values of time series graph 606.

### Exemplary Physical Plant Operation Techniques

FIG. 7 is a process flow diagram of an exemplary method 700 for operating a physical plant, in accordance with this disclosure. The exemplary method starts at block 702, where a misalignment is detected for a variable between two layers of multiple layers of optimization. In various embodiments, an alignment for each of any number of variables between two layers of optimization is identified. For example, the two layers of optimization may be two of any number of layers of optimization in a process plant. Each of the layers may have different levels of granularity and are optimized using different optimizers. Thus, one or more variables may have different optimized values in the two layers. In various embodiments, the variables may include pressure values, temperature values, among other variables.

At block 704, a degree of misalignment between the two layers of optimization is determined using a dimensionless metric. For example, in various embodiments, the degree of misalignment may be aggregated over a period of time. In various embodiments, the degree of misalignment may be aggregated for each variable. For example, the dimensionless metric can be determined for an overall application.

At block 706, the misalignment is ranked using a degree of misalignment. For example, the misalignment is ranked with respect to other detected misalignments. In some embodiments, the misalignment is ranked using economic-based metrics. For example, in some embodiments, economics of the misalignment are calculated based on shadow values. In various embodiments, the economics of the misalignment are calculated based on techniques derived from a higher-level optimization application. For example, such techniques can use the RTO model itself for higher level optimization. In some embodiments, an economic-based metric is calculated using a dummy bound and analysis tool.

At block 708, diagnostic information is determined using patterns of the ranked misalignment. For example, in some embodiments, a pattern can provide diagnostic information that includes a modification of a system, such as a MPC system or an RTO system to close an alignment gap. For example, the diagnostic information may lead to a change to a MPC or an RTO configuration and/or models. Those updates may ultimately result in the optimization of actuators moving in the plant to achieve true economic best performance.

At block 710, one or more adjustable components of a physical plant are adjusted according to the ranked misalignment to synchronize the misalignment between the two layers of optimization. For example, one or more actuators may adjust any number of adjustable components of the physical plant according to an updated MPC or RTO configuration or an updated an updated MPC or RTO model, resulting in improved performance of the physical plant. For example, the actuators may adjust one or more valves in the physical plant, or any other adjustable components of the plant.

Those skilled in the art will appreciate that the exemplary method 700 of FIG. 7 is susceptible to modification without altering the technical effect provided by this disclosure. In practice, the exact manner in which the method 700 is implemented will depend, at least in part, on the details of the specific implementation. For example, in some embodiments, some of the blocks shown in FIG. 7 may be altered or omitted from the method 700 and/or new blocks may be added to the method 700.

### Exemplary Cluster Computing System for Implementing Present Techniques

FIG. 8 is a block diagram of an exemplary cluster computing system 800 that may be utilized to implement the present techniques. The exemplary cluster computing system 800 shown in FIG. 8 has four computing units 802A, 802B, 802C, and 802D, each of which may perform calculations for a portion of the present techniques. However, one of ordinary skill in the art will recognize that the cluster computing system 800 is not limited to this configuration, as any number of computing configurations may be selected. For example, a smaller analysis may be run on a single computing unit, such as a workstation, while a large calculation may be run on a cluster computing system 800 having tens, hundreds, thousands, or even more computing units.

The cluster computing system 800 may be accessed from any number of client systems 804A and 804B over a network 806, for example, through a high-speed network interface 808. The computing units 802A to 802D may also function as client systems, providing both local computing support and access to the wider cluster computing system 800.

The network 806 may include a local area network (LAN), a wide area network (WAN), the Internet, or any combinations thereof. Each client system 804A and 804B may include one or more non-transitory, computer-readable storage media for storing the operating code and program instructions that are used to implement the present techniques. For example, each client system 804A and 804B may include a memory device 810A and 810B, which may include random access memory (RAM), read only memory (ROM), and the like. Each client system 804A and 804B may also include a storage device 812A and 812B, which may include any number of hard drives, optical drives, flash drives, or the like.

The high-speed network interface 808 may be coupled to one or more buses in the cluster computing system 800, such as a communications bus 814. The communication bus 814 may be used to communicate instructions and data from the high-speed network interface 808 to a cluster storage system 816 and to each of the computing units 802A to 802D in the cluster computing system 800. The communications bus 814 may also be used for communications among the computing units 802A to 802D and the cluster storage system 816. In addition to the communications bus 814, a high-speed bus 818 can be present to increase the communications rate between the computing units 802A to 802D and/or the cluster storage system 816.

The cluster storage system 816 can have one or more non-transitory, computer-readable storage media, such as storage arrays 820A, 820B, 820C and 820D for the storage of models, data (including core data relating to one or more wells), visual representations, results (such as graphs, charts, and the like used to convey results obtained using the present techniques), code, and other information concerning the implementation of the present techniques. The storage arrays 820A to 820D may include any combinations of hard drives, optical drives, flash drives, or the like.

Each computing unit 802A to 802D can have a processor 822A, 822B, 822C and 822D and associated local non-transitory, computer-readable storage media, such as a memory device 824A, 824B, 824C and 824D and a storage device 826A, 826B, 826C and 826D. Each processor 822A to 822D may be a multiple core unit, such as a multiple core central processing unit (CPU) or a graphics processing unit (GPU). Each memory device 824A to 824D may include ROM and/or RAM used to store program instructions for directing the corresponding processor 822A to 822D to implement the present techniques. Each storage device 826A to 826D may include one or more hard drives, optical drives, flash drives, or the like. In addition, each storage device 826A to 826D may be used to provide storage for models, intermediate results, data, images, or code associated with operations, including code used to implement the present techniques.

The present techniques are not limited to the architecture or unit configuration illustrated in FIG. 8. For example, any suitable processor-based device may be utilized for implementing all or a portion of embodiments of the present techniques, including without limitation personal computers, laptop computers, computer workstations, mobile devices, and multi-processor servers or workstations with (or without) shared memory. Moreover, embodiments may be implemented on application specific integrated circuits (ASICs) or very-large-scale integrated (VLSI) circuits. In fact, persons of ordinary skill in the art may utilize any number of suitable structures capable of executing logical operations according to embodiments described herein.

FIG. 9 is a block diagram of an exemplary non-transitory, computer-readable storage medium 900 that may be used for the storage of data and modules of program instructions for implementing the present techniques. The non-transitory, computer-readable storage medium 900 may include a memory device, a hard disk, and/or any number of other devices, as described herein. A processor 902 may access the non-transitory, computer-readable storage medium 900 over a bus or network 904. While the non-transitory, computer-readable storage medium 900 may include any number of modules (and sub-modules) for implementing the present techniques, in some embodiments, the non-transitory, computer-readable storage medium 900 includes a misalignment identifier and aggregator module 906. More specifically, the misalignment identifier and aggregator module 906 may direct the processor 902 to detect a misalignment for a variable between two layers of multiple layers of optimization. In some examples, the misalignment may be a pressure misalignment or a temperature misalignment. In various examples, the layers of optimization can include a planning layer, a scheduling layer, a real-time optimization layer, a model predictive control layer, among other layers, and any combination thereof. In various embodiments, the two layers of optimizations may have different model types, different objectives functions, and/or may be optimized using different computing devices.

In various embodiments, the misalignment identifier and aggregator module 906 also determines a degree of misalignment between the two layers of optimization using a dimensionless metric. For example, the dimensionless metric may be a piece-wise linear function of an absolute value of discrepancy for a variable. In various embodiments, the dimensionless metric quantifies a degree of alignment for the variable based on a tuning parameter. For example, the tuning parameter may be the value of a deviation parameter. In some embodiments, the degree of misalignment is aggregated over a period of time. In some embodiments, the degree of misalignment is aggregated for each variable of a number of variables.

Furthermore, in some embodiments, the non-transitory, computer-readable storage medium 900 includes a misalignment prioritizer module 908 for ranking the misalignment using the degree of misalignment. In some embodiments, ranking the misalignment includes calculating an economic value of the misalignment based on shadow values. In various embodiments, an economic-based metric is calculated. For example, the economic-based metric can be calculated using a dummy bound and analysis tool. In some embodiments, the economic-based metric is calculated using shadow values. In some embodiments, the economic-based metric is calculated via a simulation that utilizes a real-time optimization model. In some embodiments, the misalignment is ranked with respect to other detected misalignments.

In addition, in some embodiments, the non-transitory, computer-readable storage medium 900 includes a layer synchronizer module 910 for determining diagnostic information using patterns of the ranked misalignment. For example, the diagnostic information may include changes to an optimal temperature value or an optimal pressure value.

In some embodiments, the techniques are implemented using machine learning techniques. For example, a machine learning model may be trained for time series pattern recognition. In various embodiments, the machine learning model is trained using training data that includes information from various processes and optimizers. The trained machine learning model may then be used for identifying the misalignments, which are then scored and ranked according to the techniques described herein. In some embodiments, a supervised machine learning (ML) algorithm is implemented to identify the misalignments. Based on contributions to feature engineering using five unique metrics, the ML algorithm is used to detect and characterize the misalignment time series from various perspectives. Following the identification stage, the ML algorithm employs fleet-wide ML approach to try to diagnose what has been identified. In some embodiments, a multi-stage clustering approach is implemented. For example, variables are clustered according to their misalignment patterns (five metric features) followed by time-series patterns clustering to generate insights to potentially explain what is causing misalignment. The synergistic analysis allows for a more rapid investigation of the underlying causes and the formulation of an improvement solution versus an analysis conducted one variable at a time.

In this manner, the techniques described herein provide a practical application that directly improves the efficiency and accuracy of optimizing production in a process plant, by identifying misalignments between multiple layers of optimization to work towards a common goal. For example, the process plant may be a chemical processing plant, a process in a refinery, or a well production process. The information from the application may indicate what single or multiple potential root causes should be investigated in one or more of the optimization layers. A determination can then be made as to the appropriate changes to be implemented in the appropriate optimization layer(s). One or more adjustable components in a physical plant can then be adjusted according to the changes. The techniques thus further enable optimization of production rates for the overall system by generating ranked misalignments in an improved user interface.

Although embodiments herein are described with respect to oil and gas operations, one with skilled in the art will readily recognize that the techniques described herein are also suitable for application in other areas. For example, such applications may include carbon storage applications, among other applications within hydrocarbon management. It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

### Exemplary Diagnostic Features for Application

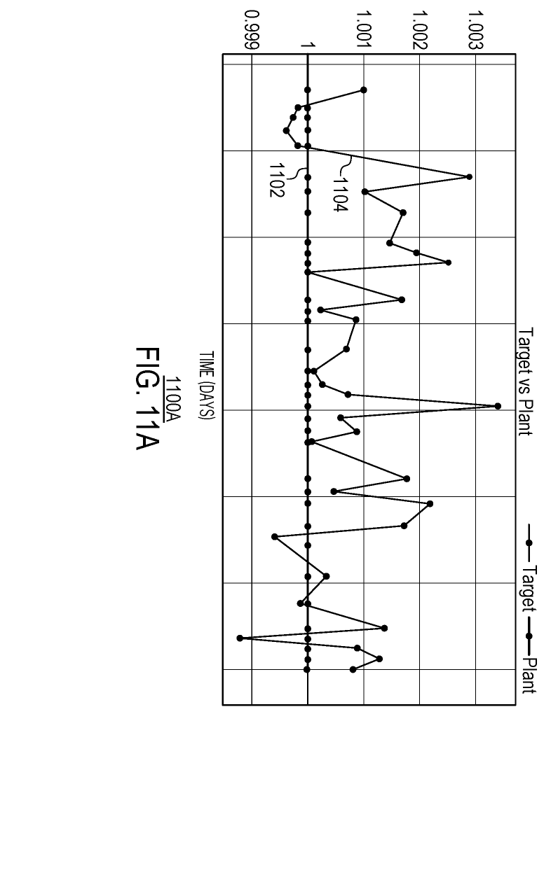

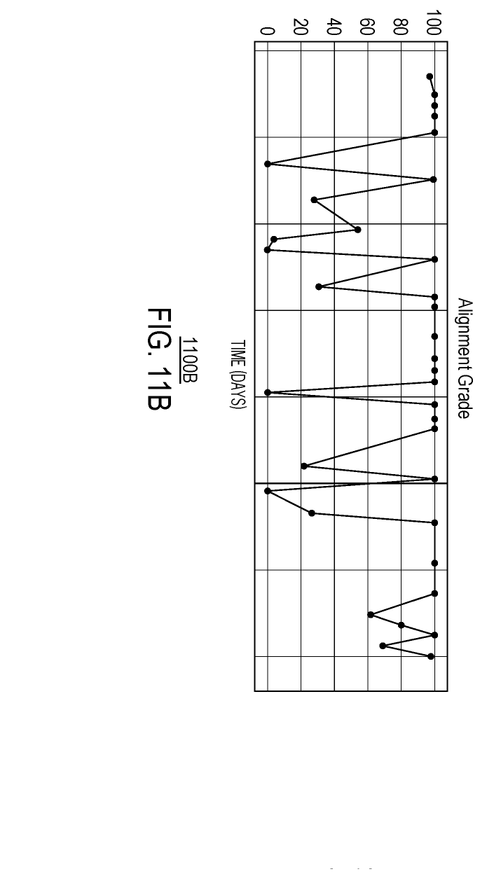

In various embodiments, the application offers intelligent filters that use pattern recognition to aid in issue detection. For example, in some embodiments, the application provides the option to filter results by external targets, Frozen PV, and Persistent Gap. The use of such intelligent filters can help users focus on specific areas of interest. For example, Frozen PV intelligent filter will display variables whose PV is not moving when the input is received into the RTO model. This can be caused by several factors. Its early detection should help the site troubleshoot this issue. For example, looking at FIG. 11A, one can see the plant PV value remains at zero.

### Exemplary Alignment Between RTO and MPC Optimization Layers

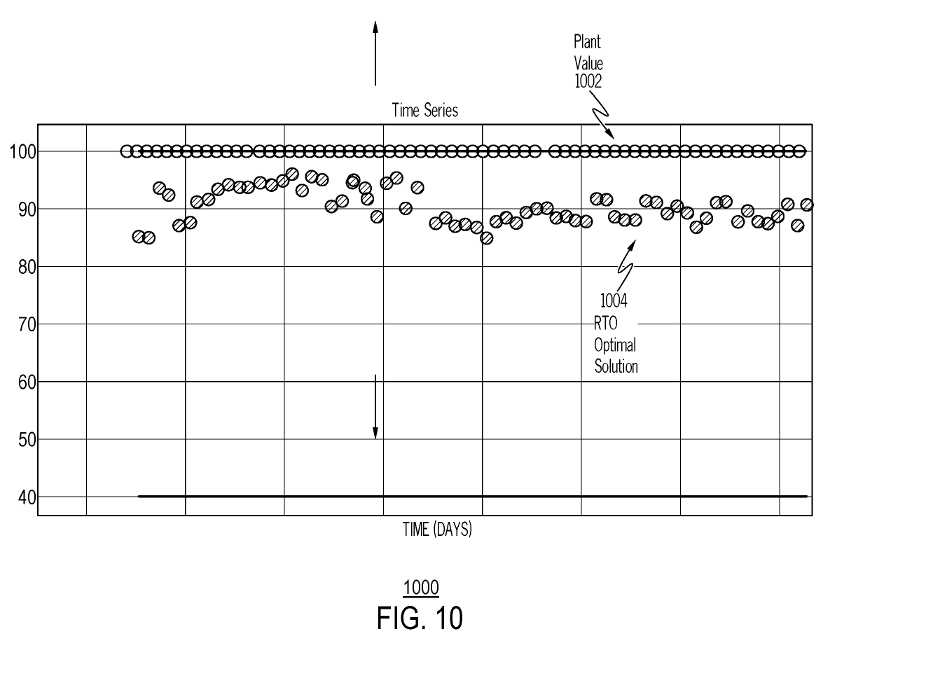

FIG. 10 is a time series graph 1000 of an exemplary detailed view for a specific variable being optimized by both an RTO and MPC. The time series graph 1000 shows values for a specific variable within the range of 40-100 on the y axis and time in increments of days along the x axis. Values for the variable from a physical plant are indicated as plant values 1002 and values from an RTO optimizer are indicated (as RTO optimal solution values 1004. In assessing an alignment between RTO and MPC applications, the following questions were asked: “Why was there a discrepancy between this RTO handle and the process?” and “Why is this variable not being reduced per the expected optimization?”

The alignment algorithm results highlighted the misalignment via a low dimensionless metric score. Looking at the detailed view for the specific variable in FIG. 10, the RTO was calculating a reduction to the variable. However, the MPC was not driving the process in that direction. Thus, the MPC drives were not aligned to implement this solution. As a result, the RTO solution was not being implemented. In this example, the optimization drives in the MPC were thus be changed to align these two models of optimization. For example, an external target could be configured in the MPC layer (with a value coming from the RTO layer) to align the RTO and MPC drives.

In various embodiments, another diagnostic feature can address variables that display persistent gap between an RTO solution and a plant value. For example, an RTO may be calculating a solution, while the MPC is moving the plant in a different direction, ignoring the online optimized solution. An example of such a persistent gap is shown analyzed using the frozen PV intelligent filter of FIGS. 11A and 11B.

FIGS. 11A and 11B are screenshots of an exemplary frozen PV intelligent filter. The screenshot of FIG. 11A includes a trends time series graph 1100A. Looking at the trends time series graph 1100A, there is a discrepancy between the plant values 1102 and the optimized target value 1104. The plant value has been detected to be constant at a value of 1. In particular, the RTO appears to want to increase the value most of the time, but the plant value is not moving from this signal (as if frozen). In various embodiments, one or more actions may be taken to resolve the underlying cause of the unresponsive plant value.

The screenshot of FIG. 11B shows an alignment grade time series graph 1100B corresponding to the same period of FIG. 11A. Again, as seen in FIG. 11A, the frozen plant value is not moving from this signal (as if frozen), resulting in various misalignments.

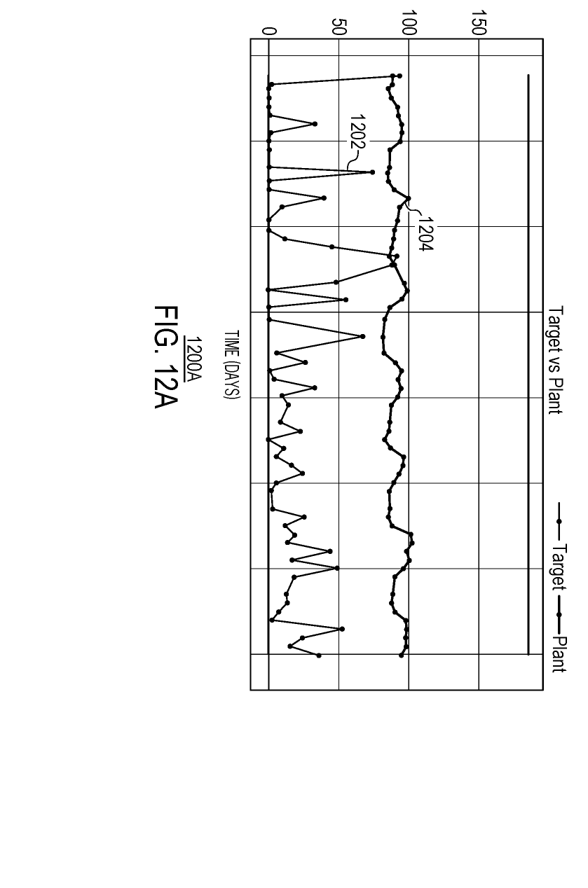

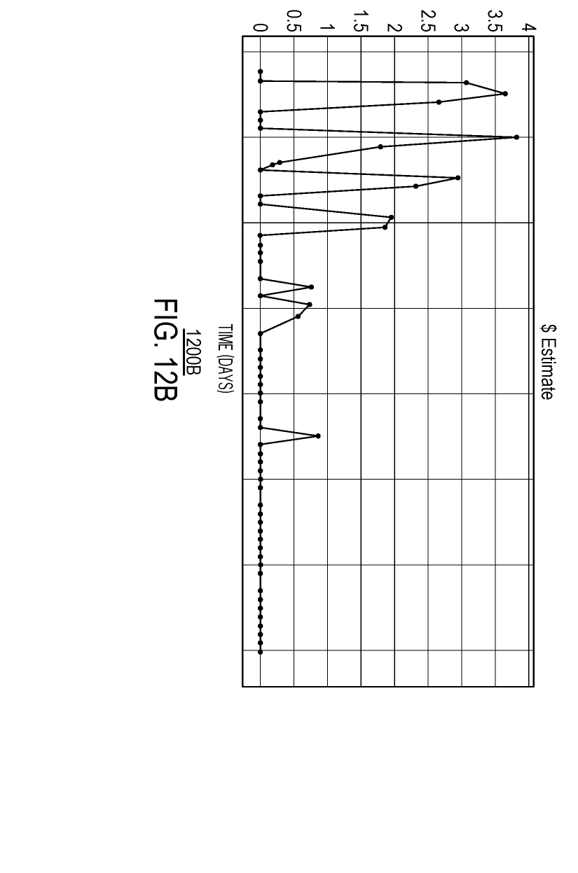

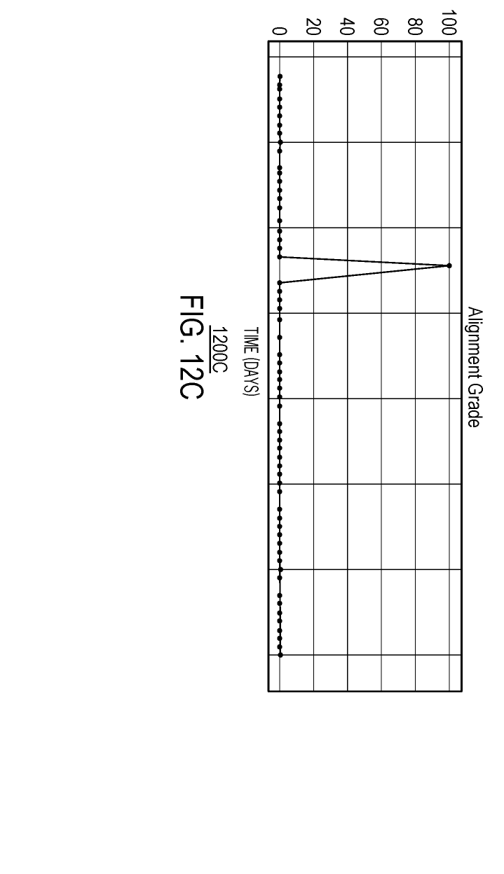

FIGS. 12A, 12B, and 12C are screenshots of a detailed portal page displaying an exemplary persistent gap for the DRAG variable in a specific unit. The example portal page screenshot of FIG. 12A shows a trends time series graph 1200A. In the example of FIG. 12A, the trends time series graph 1200A demonstrates a persistent gap between the target values 1202 and the plant values 1204. In various examples, the persistent gap may be detected using the techniques described herein, and one or more measures taken to address the persistent gap. For example, an external target could be configured in the MPC layer (with a value coming from the RTO layer) to align the RTO and MPC drives. In some examples, another option could be to ensure model consistency between the two layers of optimization. For example, ensuring model consistency may involve ensuring consistent model gains.

The screenshot of FIG. 12B shows a cost estimate graph 1200B that depicts the costs associated with the discrepancies shown in FIG. 12A over the same period of time.

The screenshot of FIG. 12C shows an alignment graph time series graph 1200C that depicts misalignment over the same period as FIGS. 12A and 12B. As shown in FIG. 12C, the only period of 100% alignment was during some time on June 26^{th}.

### Embodiments of Present Techniques

In one or more embodiments, the present techniques may be susceptible to various modifications and alternative forms, such as the following embodiments as noted in paragraphs 1 to 32:

1. A system that includes a computer program that detects a misalignment for a variable between two layers of multiple layers of optimization, determines a degree of the misalignment between the two layers of optimization using a dimensionless metric, ranks the misalignment using a degree of the misalignment, and determines diagnostic information using patterns of the ranked misalignment. The system includes a physical plant that includes adjustable components that are adjusted using the diagnostic information according to the ranked misalignment to synchronize the misalignment between the two layers of optimization.

2. The system of paragraph 1, where the ranking relates to a severity of a diagnostic issue.

3. The system of any of paragraphs 1 and 2, where the two layers include different model types or different objective functions.

4. The system of any of paragraphs 1 to 3, where the two layers are optimized using different computing devices.

5. The system of any of paragraphs 1 to 4, where the dimensionless metric quantifies a degree of alignment for the variable over a period of time based on a tuning parameter.

6. The system of paragraph 5, where the degree of alignment is further based on a calculated discrepancy between the two layers and a scoring function to convert the discrepancy scaled by the tuning parameter into a metric.

7. The system of any of paragraphs 1 to 6, where the dimensionless metric includes a linear function of an absolute value of discrepancy for a variable.

8. The system of any of paragraphs 1 to 7, where the processor is configured to identify an alignment for each variable between the two layers of the multiple layers of optimization.

9. The system of any of paragraphs 1 to 8, where the multiple layers of optimization include a planning layer, a scheduling layer, a real-time optimization layer, a model predictive control layer, a base control layer, or any combination thereof.

10. The system of any of paragraphs 1 to 9, where the misalignment is mapped to an economic metric using model calculations, a marginal analysis, or both.

11. The system of any of paragraphs 1 to 10, where the diagnostic information is determined using an economic-based metric includes an economic-based metric that uses a model-based analysis to quantify an economic incentive of the aggregated misalignment.

12. The system of any of paragraphs 1 to 11, where an update to a model or an update to a configuration of a system of the two layers of optimization is performed in response to the diagnostic information.

13. The system of any of paragraphs 1 to 12, where the detected misalignment includes a measurable parameter from process instruments including pressure, temperature, flow rate, a product specification, chemical composition, or any combination thereof.

14. The system of any of paragraphs 1 to 13, wherein the detected misalignment includes a misalignment in a measurable parameter from process instruments comprising pressure, temperature, flow rate, a product specification, chemical composition, or any combination thereof, wherein determination of the degree of misalignment includes quantifying over a period of time a degree of alignment for the pressure, temperature, flow rate, a product specification, chemical composition, or any combination thereof based on a tuning parameter and converting a discrepancy in the alignment scaled by the tuning parameter into a metric using a scoring function, and wherein the ranking the misalignment includes ranking based on the metric, wherein the physical plant comprises an oil, gas, or petrochemical plant that includes an actuator that is adjusted to reduce a higher ranked misalignment in the pressure, temperature, flow rate, a product specification, chemical composition, or any combination thereof.

15. A method of operating a physical plant that includes detecting a misalignment for a variable between two layers of multiple layers of optimization, determining a degree of misalignment between the two layers of optimization using a dimensionless metric, ranking the misalignment using a degree of the misalignment, determining diagnostic information using patterns of the ranked misalignment, and adjusting adjustable components of the physical plant using the diagnostic information according to the ranked misalignment to synchronize the misalignment between the two layers of optimization.

16. The method of paragraph 15, where the degree of misalignment is aggregated over a period of time.

17. The method of any of paragraphs 15 and 16, where the degree of misalignment is aggregated for each variable of a plurality of variables.

18. The method of any of paragraphs 15 to 17, where ranking the misalignment includes calculating economics of the misalignment based on shadow values.

19. The method of any of paragraphs 15 to 18, where ranking the misalignment includes calculating an economic value of the misalignment based on techniques derived from an optimization application.

20. The method of any of paragraphs 15 to 19, where the misalignment is ranked with respect to other detected misalignments.

21. The method of any of paragraphs 15 to 20, including calculating an economic-based metric using an analysis tool.

22. The method of any of paragraphs 15 to 21, where the dimensionless metric includes a linear function of an absolute value of discrepancy for a variable.

23. The method of any of paragraphs 15 to 22, where the dimensionless metric quantifies a degree of alignment for the variable based on a tuning parameter.

24. The method of paragraph 23, where the degree of alignment is further based on a calculated discrepancy between the two layers and a scoring function to convert the discrepancy scaled by the tuning parameter into a metric.

25. The method of any of paragraphs 15 to 24, including calculating an economic-based metric using shadow values.

26. The method of any of paragraphs 15 to 25, where the economic-based metric is calculated via a simulation that utilizes an economic model.

27. The method of any of paragraphs 15 to 26, where the detected misalignment includes a measurable parameter from process instruments including pressure, temperature, flow rate, a product specification, chemical composition, or any combination thereof.

28. The method of any of paragraphs 15 to 27, where the change to improve performance includes an update to a model of a system of the two layers of optimization.

29. The method of any of paragraphs 15 to 28, where the change to improve performance includes an update to a configuration of a system of the two layers of optimization.

30. The method of any of paragraphs 15 to 29, where the adjusting of the adjustable components is performed by a user based using the diagnostic information.

31. The method of any of paragraphs 15 to 30, where the ranking relates to a severity of a diagnostic issue.

32. The method of any of paragraphs 15 to 31, wherein detecting the misalignment comprises detecting a misalignment in a measurable parameter from process instruments comprising pressure, temperature, flow rate, a product specification, chemical composition, or any combination thereof, wherein determining the degree of misalignment comprises quantifying over a period of time a degree of alignment for the pressure, temperature, flow rate, a product specification, chemical composition, or any combination thereof based on a tuning parameter and converting a discrepancy in the alignment scaled by the tuning parameter into a metric using a scoring function, and wherein ranking the misalignment comprises ranking based on the metric, wherein the physical plant comprises an oil, gas, or petrochemical plant that comprises an actuator that is adjusted to reduce a higher ranked misalignment in the pressure, temperature, flow rate, a product specification, chemical composition, or any combination thereof.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. In addition, all numerical values within the detailed description herein are modified by “about” the indicated value, and take into account experimental error and variations that would be expected by a person having ordinary skill in the art. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A system, comprising:
(i) a computer program that:
detects a misalignment for a variable between two layers of multiple layers of optimization;
determines a degree of the misalignment between the two layers of optimization using a dimensionless metric;
ranks the misalignment using the degree of the misalignment;
determines diagnostic information using patterns of the ranked misalignment; and
(ii) a physical plant that includes adjustable components that are adjusted using the diagnostic information according to the ranked misalignment to synchronize the misalignment between the two layers of optimization.

2. The system of claim 1, wherein the ranking relates to a severity of a diagnostic issue.

3. The system of claim 1, wherein the two layers comprise different model types or different objective functions.

4. The system of claim 1, wherein the two layers are optimized using different computing devices.

5. The system of claim 1, wherein the dimensionless metric quantifies a degree of alignment for the variable over a period of time based on a tuning parameter.

6. The system of claim 5, wherein the degree of alignment is further based on a calculated discrepancy between the two layers and a scoring function to convert the discrepancy scaled by the tuning parameter into a metric.

7. The system of claim 1, wherein the dimensionless metric comprises a linear function of an absolute value of discrepancy for a variable.

8. The system of claim 1, wherein the computer program is configured to identify an alignment for each variable between the two layers of the multiple layers of optimization.

9. The system of claim 1, wherein the multiple layers of optimization comprise a planning layer, a scheduling layer, a real-time optimization layer, a model predictive control layer, a base control layer, or any combination thereof.

10. The system of claim 1, wherein the detected misalignment includes a misalignment in a measurable parameter from process instruments comprising pressure, temperature, flow rate, a product specification, chemical composition, or any combination thereof, wherein determination of the degree of misalignment includes quantifying over a period of time a degree of alignment for the pressure, the temperature, the flow rate, the product specification, the chemical composition, or any combination thereof based on a tuning parameter and converting a discrepancy in the alignment scaled by the tuning parameter into a metric using a scoring function, and wherein the ranking of the misalignment includes ranking based on the metric, wherein the physical plant comprises an oil, gas, or petrochemical plant that includes an actuator that is adjusted to reduce a higher ranked misalignment in the pressure, the temperature, the flow rate, the product specification, the chemical composition, or any combination thereof.

11. A method of operating a physical plant, comprising:
detecting a misalignment for a variable between two layers of multiple layers of optimization;
determining a degree of misalignment between the two layers of optimization using a dimensionless metric;
ranking the misalignment using the degree of the misalignment;
determining diagnostic information using patterns of the ranked misalignment; and
adjusting adjustable components of the physical plant using the diagnostic informationaccording to the ranked misalignment to synchronize the misalignment between the two layers of optimization.

12. The method of claim 11, wherein the degree of misalignment is aggregated over a period of time.

13. The method of claim 11, wherein the degree of misalignment is aggregated for each variable of a plurality of variables.

14. The method of claim 11, wherein ranking the misalignment comprises calculating economics of the misalignment based on shadow values.

15. The method of claim 11, wherein ranking the misalignment comprises calculating an economic value of the misalignment based on techniques derived from an optimization application.

16. The method of claim 11, wherein the misalignment is ranked with respect to other detected misalignments.

17. The method of claim 11, comprising calculating an economic-based metric using an analysis tool.

18. The method of claim 11, wherein the dimensionless metric comprises a linear function of an absolute value of discrepancy for a variable.

19. The method of claim 11, wherein the dimensionless metric quantifies a degree of alignment for the variable based on a tuning parameter.

20. The method of claim 11, wherein detecting the misalignment comprises detecting a misalignment in a measurable parameter from process instruments comprising pressure, temperature, flow rate, a product specification, chemical composition, or any combination thereof, wherein determining the degree of misalignment comprises quantifying over a period of time a degree of alignment for the pressure, the temperature, the flow rate, the product specification, the chemical composition, or any combination thereof based on a tuning parameter and converting a discrepancy in the alignment scaled by the tuning parameter into a metric using a scoring function, and wherein ranking the misalignment comprises ranking based on the metric, wherein the physical plant comprises an oil, gas, or petrochemical plant that comprises an actuator that is adjusted to reduce a higher ranked misalignment in the pressure, the temperature, the flow rate, the product specification, chemical composition, or any combination thereof.
